(19) United States
(12) Patent Application Publication
(10) Pub. No.: US 2008/0019121 A1
(43) Pub. Date: Jan. 24, 2008

(54) ILLUMINATED TILE AND METHOD OF PRODUCING THE SAME

(75) Inventor: Hung P. Ly, Kent, WA (US)

Correspondence Address: AXIOS LAW GROUP. PLLC, 1525 FOURTH AVENUE, SUITE 800, SEATTLE, WA, 98101, US

(73) Assignee: MESA DESIGN LLC, Kent, WA (US)

(21) Appl. No.: 11/782,197

(22) Filed: Jul. 24, 2007

Related U.S. Application Data
(60) Provisional application No. 60/820,177, filed on Jul. 24, 2006.

(51) Int. Cl. F21S 8/00

(52) U.S. Cl. 362/145; 362/411; 362/552

(57) ABSTRACT

An illuminated tile and a method for producing the same are provided herein.

### RELATED REFERENCES

This application claims priority to U.S. Provisional Application No. 60/820,177, filed Jul. 24, 2006, the contents of which are incorporated herein by reference in their entirety.

### FIELD

The present invention relates to illuminated tiles, and more particularly to illuminated tiles having a recess or recesses filled with a light-transmissive medium.

### BACKGROUND

A conventional tile is a manufactured piece of hard-wearing material such as ceramic, stone, metal, concrete, or even glass or crystal. Originally developed to cover roofs, tiles are now commonly used to cover not only roofs, but also floors, walls, countertops, and other objects such as tabletops. Tiles can serve both a utilitarian purpose, such as by providing a durable and protective surface, and an aesthetic purpose, such as by having decorative upper surfaces or by being laid in attractive patterns, or even displayed on their own.

Although tiles themselves have existed for thousands of years, illuminated tiles have not existed in the market until recently. An illuminated tile is one that has an integrated light source designed to light up a portion of the tile itself, to provide light to its immediate surroundings, or to make the tile “glow” in an attractive fashion. Illuminated tiles are relative newcomers at least in part because until recently, there were few light sources that were sufficiently small, long lived, bright, and efficient to make an illuminated tile commercially viable.

In recent years, however, appropriate light sources have become widely available and more cost effective. One of the more common such light sources is the light-emitting diode (LED). Because LEDs tend to be inexpensive, low-power, compact, bright, efficient, and long lasting light sources, LEDs have opened up new possibilities for making illuminated tiles. However, illuminated tiles produced thus far have tended to suffer from a number of deficiencies, including high cost and complex fabrication requirements. Existing illuminated tiles also tend to lack aesthetic appeal when they are powered off.

### BRIEF DESCRIPTION OF THE DRAWINGS

FIG. 1 is a view of an illuminated tile, in accordance with one embodiment.

FIG. 2 is a cutaway view of the illuminated tile illustrated in FIG. 1.

FIG. 3 is a view of the underside of the illuminated tile illustrated in FIG. 1.

FIG. 4 is a view of an illuminated tile with a reflective coating on a surface of the recess, in accordance with one embodiment.

FIG. 5 is a view of an illuminated tile with a textured coating on a surface of the recess, in accordance with one embodiment.

FIG. 6 is a cutaway view of an illuminated tile whose recess is filled with two layers of a light-transmissive medium, in accordance with one embodiment.

FIG. 7 is a view of an illuminated tile whose recess is filled with two layers of a light-transmissive medium with a printed transparency between the two layers, in accordance with one embodiment.

FIG. 8 is a view of an illuminated tile with an object partially embedded in its light-transmissive medium, in accordance with one embodiment.

FIG. 9 is a view of an illuminated tile with an object partially embedded in its light-transmissive medium and a light source located beneath the object, in accordance with one embodiment.

FIG. 10 is a cutaway view of the illuminated tile illustrated in FIG. 9.

FIG. 11 is a cutaway view of an illuminated tile whose recess is filled with a protruding light-transmissive medium, in accordance with one embodiment.

FIG. 12 is a cutaway view of an illuminated tile whose recess is filled with two layers of light-transmissive medium, the top layer being a sheet of glass, in accordance with one embodiment.

FIG. 13 is a cutaway view of an illuminated tile with light from the light source totally reflected by the top surface of the light-transmissive medium, in accordance with one embodiment.

FIG. 14 is a cutaway view of an illuminated tile with light from the light source partially reflected and partially refracted by the top surface of the light-transmissive medium, in accordance with one embodiment.

FIG. 15 is a view of an illuminated tile coupled to a free-standing stand, in accordance with one embodiment.

FIG. 16 is a rear view of the illuminated tile illustrated in FIG. 15.

FIG. 17 is a view of an illuminated tile coupled with a power source having a domestic power plug, in accordance with one embodiment.

FIG. 18 is a view of a light source and a power source mounted to a substrate, in accordance with one embodiment.

FIG. 19 illustrates the relationship between the substrate illustrated in FIG. 18 and a tile base that the substrate can be coupled with, in accordance with one embodiment.

FIG. 20 is a view of the tile base and substrate illustrated in FIG. 19 coupled together, in accordance with one embodiment.

FIG. 21 illustrates an illuminated tile that can removably couple with a connector box, in accordance with one embodiment.

FIG. 22 illustrates illuminated tiles affixed to a wall, in accordance with one embodiment.

FIG. 23 illustrates a power source, a control tile, and three illuminated tiles connected in series, in accordance with one embodiment.

FIG. 24 illustrates a power source, a control tile, and three illuminated tiles connected in parallel, in accordance with one embodiment.

FIG. 25 is a view of a perforation tool, in accordance with one embodiment.

FIG. 26 illustrates the perforation tool illustrated in FIG. 25 being used to form perforations and a channel in an illuminated tile, in accordance with one embodiment.

FIG. 27 is a view of a master mold used to form an illuminated tile, in accordance with one embodiment.

FIG. 28 is a view of an illuminated tile with a light source located in a raised terrace in the middle of the recess, in accordance with one embodiment.

FIG. 29 is a cutaway view of the illuminated tile illustrated in FIG. 28, in accordance with one embodiment.

### DESCRIPTION

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

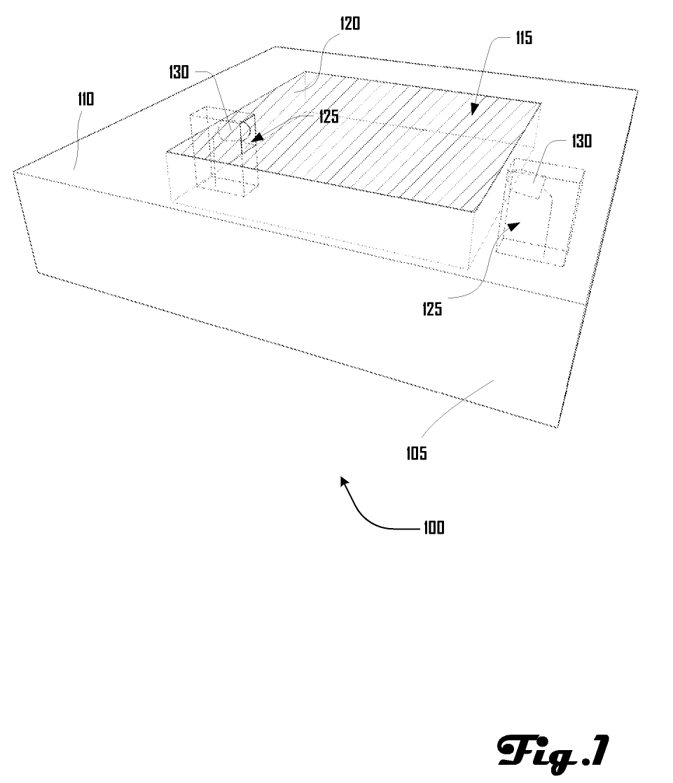

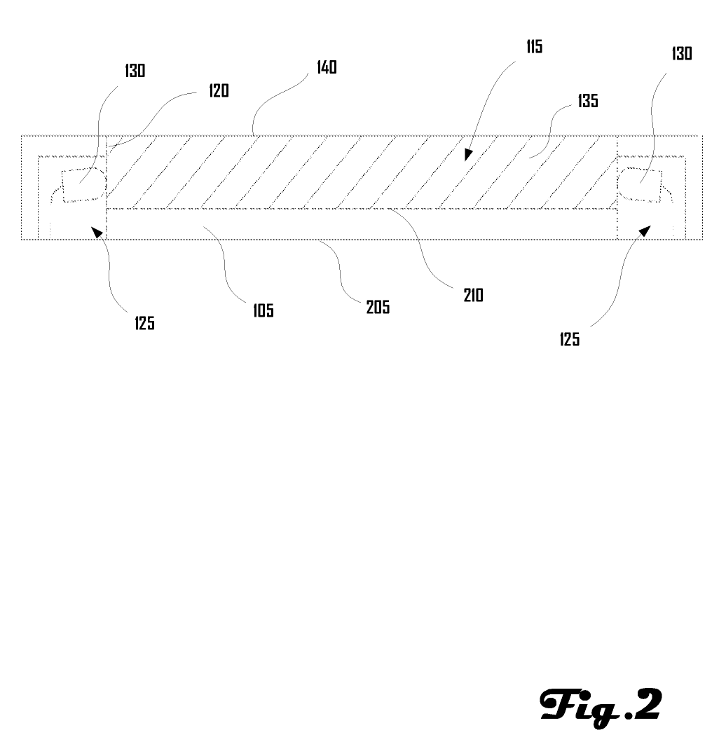

FIGS. 1 and 2 are views of an illuminated tile 100. There is a recess 115 in the upper surface 110 of the base 105 of the illuminated tile 100. The recess 115 has a bottom 210 and is filled with a light-transmissive medium 135. Perforations 125 provide an opening from the lower surface 205 of the base 105 through to an edge 120 of the recess 115. Small light sources 130 have been inserted through perforations 125 in the base 105 such that they project light towards an edge 120 of the recess 115 and into the light-transmissive medium 135.

The light source(s) 130 may be any relatively compact, relatively efficient, relatively long-lived producer of light. Examples of suitable light sources include LEDs, “optical fiber,” incandescent, halogen, or compact fluorescent lamps, and “luminescent” light sources.

Luminescence is light not generated by high temperatures alone and thus may occur at low temperatures. Luminescence can be caused by, for example, chemical reactions, electrical energy, subatomic motions, or stress on a crystal.

An optical fiber is a glass or plastic fiber designed to guide light along its length by confining as much light as possible in a propagating form. Optical fiber illumination is often used for decorative applications, including signs, art, and artificial Christmas trees.

40 In an exemplary embodiment, when the light sources 130 are lit, the light they produce is diffused, reflected, and/or refracted by the light-transmissive medium and/or the edges 120 and bottom 210 of the recess 115, thereby evenly illuminating the light-transmissive medium 135 through the use of only one or a few individual light sources 130. To accomplish this even illumination, in most embodiments, the light source 130 will be oriented so that the light it emits is directed in a direction other than directly at the upper surface 140 of the light-transmissive medium 135. If light from the light source 130 were to be directed directly at the upper surface 140 of the light-transmissive medium 135, then it is likely that an even illumination of the light-transmissive medium 135 would not be accomplished; rather, individual light sources 130 could be perceived.

The light-transmissive medium 135 may be made of most any material that transmits light. In exemplary embodiments, the light-transmissive medium 135 may be a liquid that hardens after it is poured into the recess 115, such as acrylic, epoxy, or any other light-transmissive resin compound. In alternate embodiments, liquid glass or other suitable materials may be used.

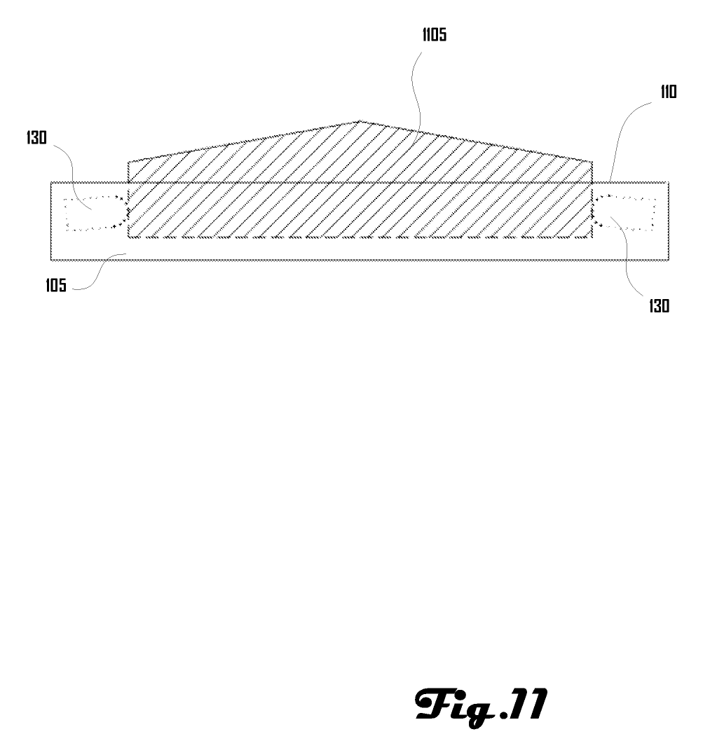

The light-transmissive medium 135 may also be a solid material that is affixed into the recess 1 15. Such material may be glass, plexiglass, amber or any other suitable material. As illustrated in FIG. 11, in one embodiment, the light-transmissive medium may be formed to extend or protrude higher than the upper surface 110 of the base 105, which may create a pleasing decorative effect.

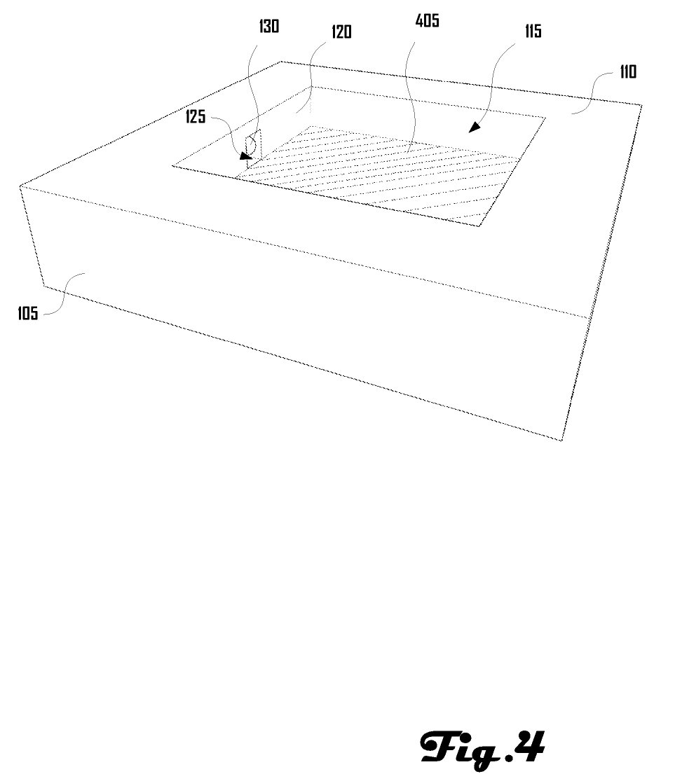

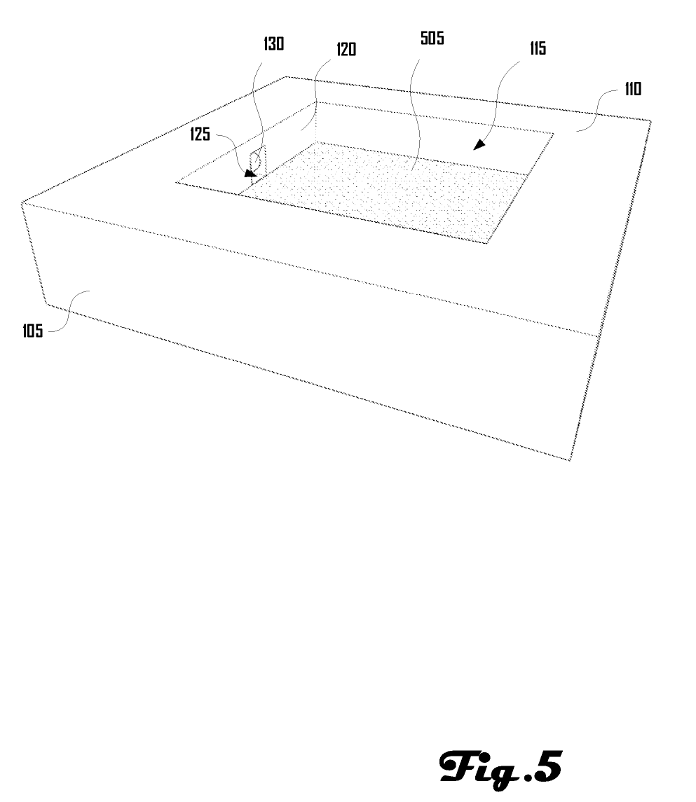

As illustrated in FIG. 4, to alter the aesthetic appeal of an illuminated tile 100, one or more edges 120 and/or the bottom 210 of the recess 115 may have a reflective coating 405, such as a piece of mirror, glitter paint, reflective foil, or even simply white or colored paint. As illustrated in FIG. 5, one or more edges 120 and/or the bottom 210 of the recess 115 may have a textured coating 505, such as sand, applied. In other embodiments, these two techniques may be combined, as if sand were mixed with glitter paint to create a reflective and textured coating on one or more edges 120 and/or the bottom 210 of the recess 115.

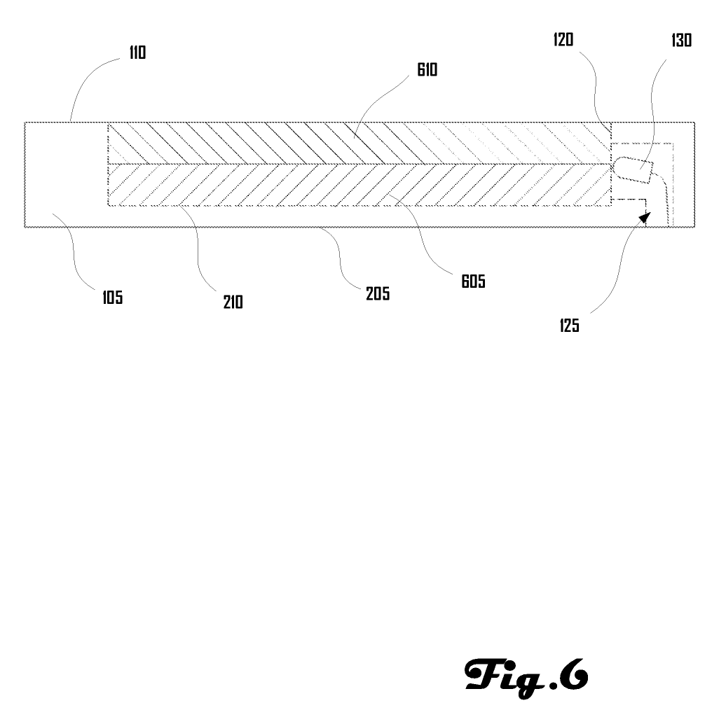

As illustrated in FIG. 6, the light-transmissive medium 135 may be made up of more than one layer. In one embodiment, a first layer 605 may be poured, molded, or otherwise placed into the recess 115, followed by a second layer 615 of a similar or different material. In other embodiments, there may be additional layers. Differing optical properties of differing materials may be exploited for different aesthetic effects. For example one or more layers could be tinted, could have reflective flakes suspended therein, or could have some other treatment that causes an optical effect.

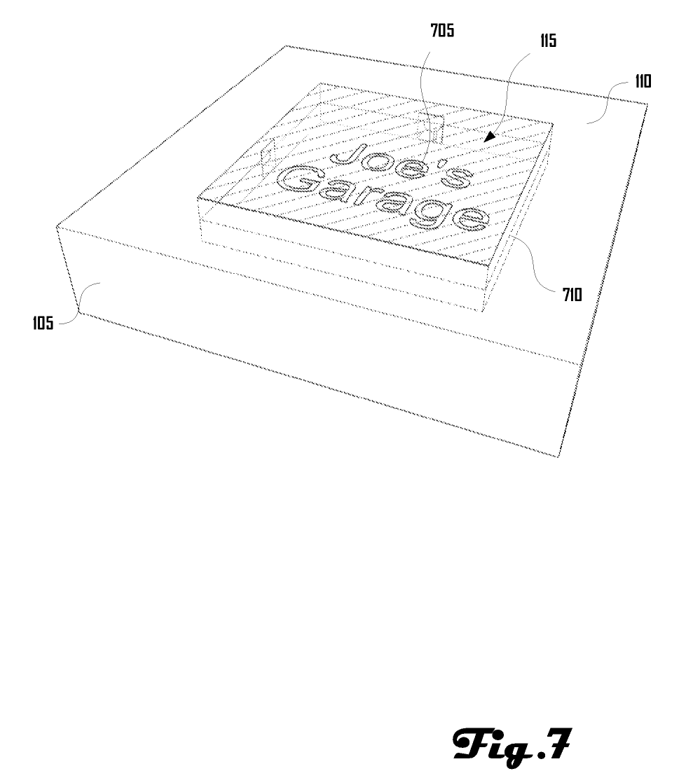

As illustrated in FIG. 7, a layer 710 may be placed between a first light transmissive layer 605 and a second light transmissive layer 610. In one embodiment, the further transparent layer 710 may be a transparency printed with a company logo, team logo, personalized picture, business card information, or virtually any other image 705. Such a layer 710 may be created and customized using conventional software and available hardware (e.g., a personal computer and a digital printer). Thus, custom-designed tiles could be easily and inexpensively created by using a transparency as the layer 710 between two light-transmissive layers 605, 610.

In alternate embodiments, the layer 710 between a first light transmissive layer 605 and a second light transmissive layer 610 may be a piece of paper, tracing paper, or other translucent material. Such a layer 710 may also be printed with a logo, picture, text, or other image. Such a layer 710, whether transparent or translucent, may also be decorated by hand or otherwise marked using any suitable method.

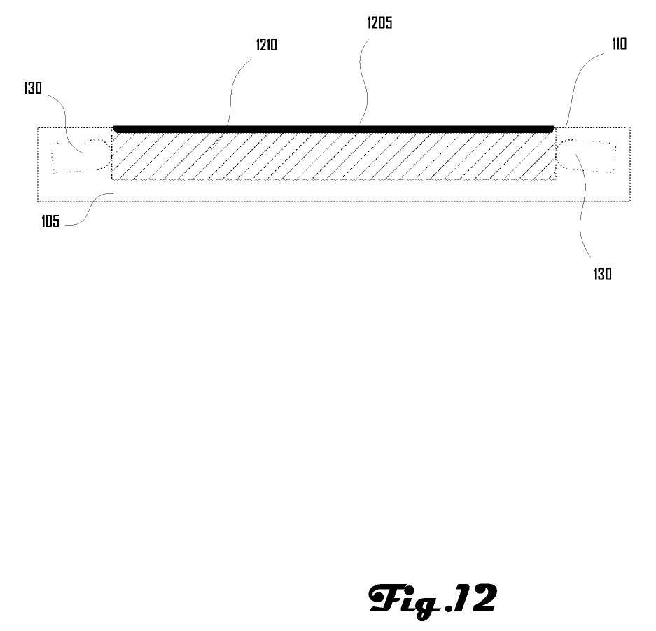

In other embodiments, a decorative layer may take other configurations. For example, FIG. 12 illustrates one embodiment, in which a solid light-transmissive medium layer 1205 such as a piece of glass may be placed on top of a lower layer 1210 of a hardened liquid such as epoxy or acrylic. Such a piece of glass may be stained, frosted, etched, or otherwise decorated, and it may appear to glow from within in a pleasing manner if arranged in this way. Additionally, glass or other light-transmissive materials such as quartz or the like may provide a more durable surface than a plastic resin. Such a glass or other light-transmissive material may cover just the lower layer 1210, or in alternate embodiments may cover the lower layer 1210 and the rest of the face of the tile 100.

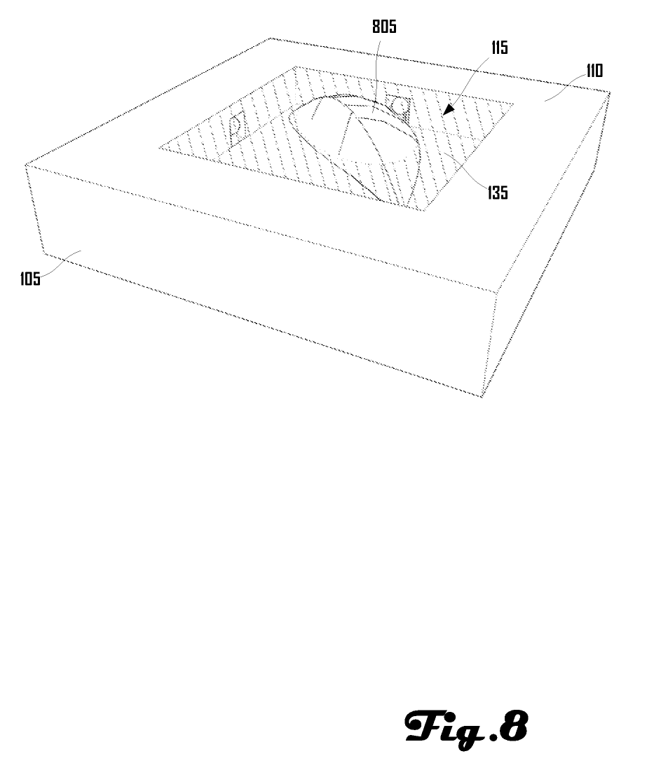

FIGS. 7 and 12 illustrated illuminated tiles having different types of decorative light-transmissive layers. In other embodiments, decoration may take other forms. For example, as illustrated in FIG. 8, an object 805, such as a leaf, ring, coin, sea shell, stone, or any other appropriately sized object, may be embedded in the light-transmissive medium 135. Such object 805 may be pleasingly illuminated when the light source 130 is turned on.

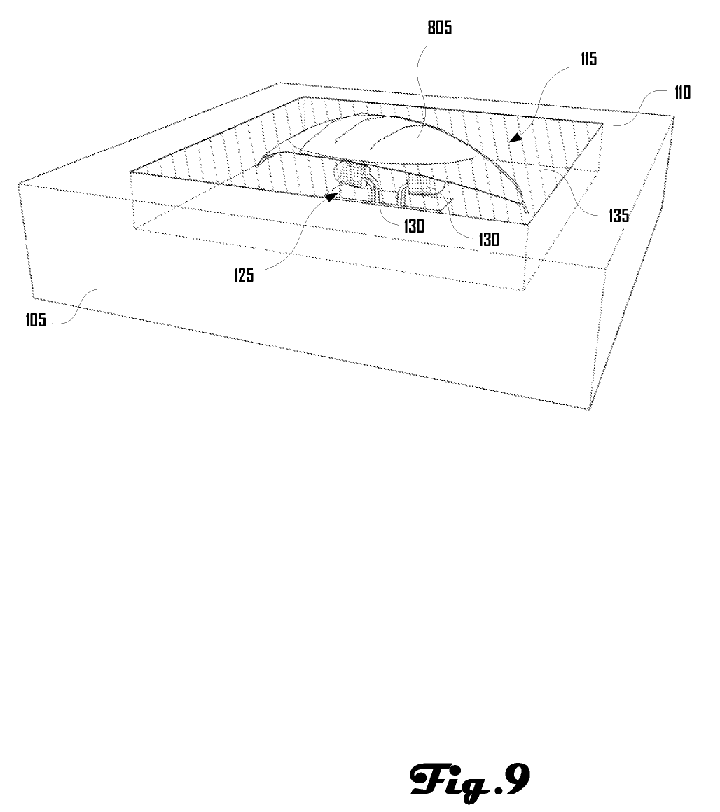

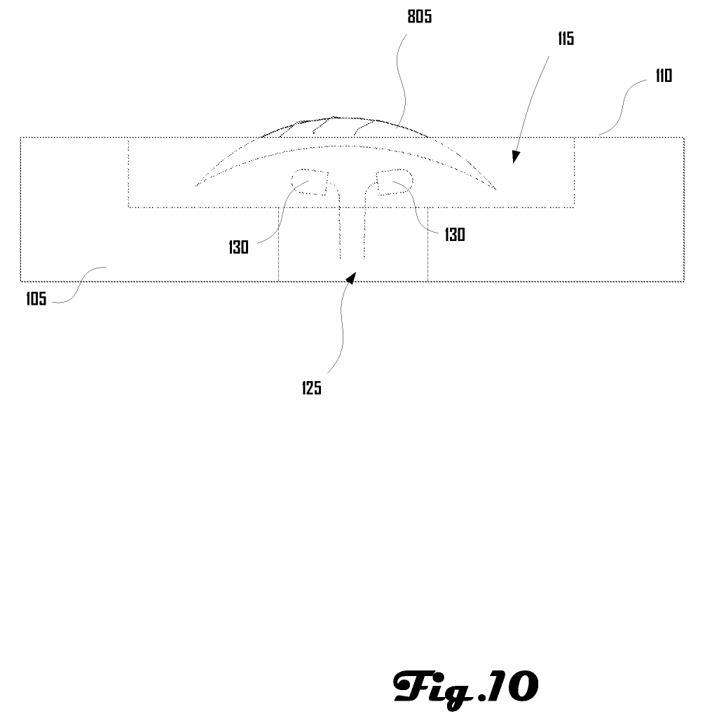

As illustrated in FIGS. 9 and 10, in alternate embodiments, a light source 130 may be located beneath an object 805. If the object 805 is hollow, a light source may even be placed inside the object 805. Such light source 130 placement may cause it to appear as if the object 805 itself were luminescent.

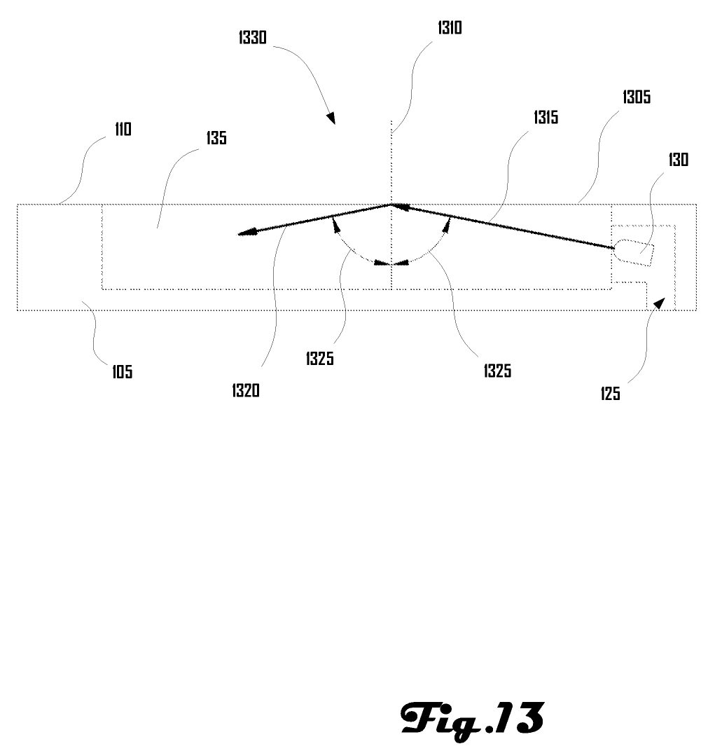

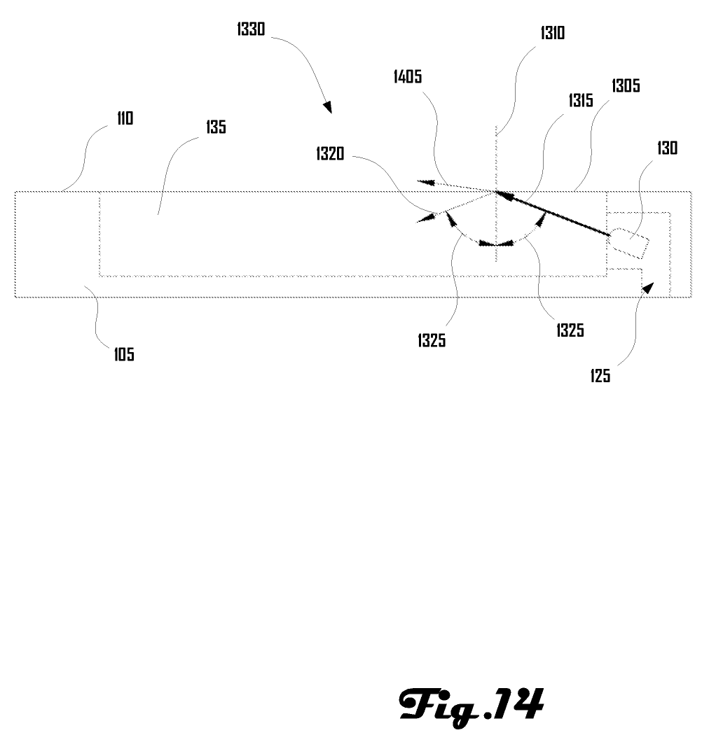

In some embodiments, it may be desirable to make it appear as though the light-transmissive medium 135 were evenly illuminated, making individual light sources 130 difficult to perceive. As illustrated in FIGS. 13 and 14, the angle of incidence 1325 at which light 1315 emitted from a light source 130 intersects the “normal” 1310 to the surface 1305 of the light-transmissive medium 135 determines what portion of the light 1315 is internally reflected 1320 and what portion is refracted 1405 as it passes out of the light-transmissive medium 135. The light 1315 will be totally internally reflected (no light 1315 will pass through the surface 1305) when it strikes the surface 1305 of the light-transmissive medium 135 at an angle 1325 larger than the “critical angle” with respect to the normal 1310 to the surface 1305.

A normal to a flat surface, such as the surface 1305 of the light-transmissive medium 135 in many embodiments, is a three-dimensional vector that is perpendicular to that surface.

The critical angle is the angle of incidence above which total internal reflection occurs. The critical angle θ is given by:

$${θ}_{c} = arcsin ( \frac{{n}_{2}}{{n}_{1}} )$$

where n₂ is the refractive index of the less dense medium 1330, and n₁ is the refractive index of the denser medium 135. If the angle of incidence 1325 is less than the critical angle, then a portion of the light 1315 will be refracted 1405 as it passes into the medium 1330 surrounding the tile 100. In exemplary embodiments, that medium 1330 may be air, but in other embodiments, that medium may be water or some other liquid or gas. In some embodiments, total internal reflection of the light 1315 may be desirable because the light 1315 will then be scattered as it reflects off of one or more edges 120 and/or the bottom 210 of the recess 115. As a result, the light-transmissive medium 135 may appear to glow evenly, rather than have identifiable individual sources of light. In other embodiments, such an even glow may be accomplished by reflecting the light 1315 off of one or more edges 120 and/or the bottom 210 of the recess 115, rather then reflecting or refracting light off the surface 1305 of the light-transmissive medium 135. In such embodiments, one or more edges 120 and/or the bottom 210 of the recess 115 may have a reflective coating 405 or textured coating 505 that may help to evenly disperse the light throughout the light-transmissive medium 135. The method used to illuminate the light-transmissive medium 135 may vary depending on the size of the recess 115.

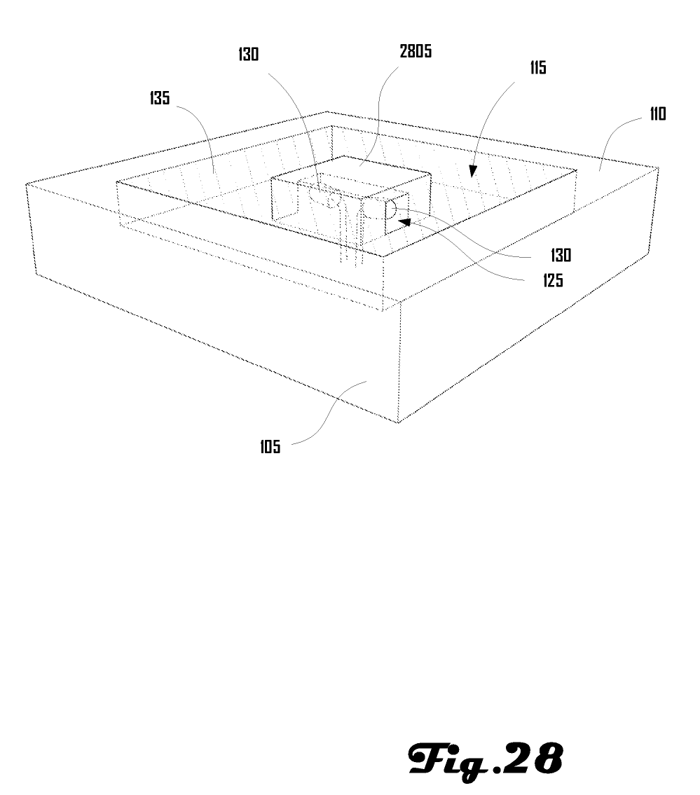

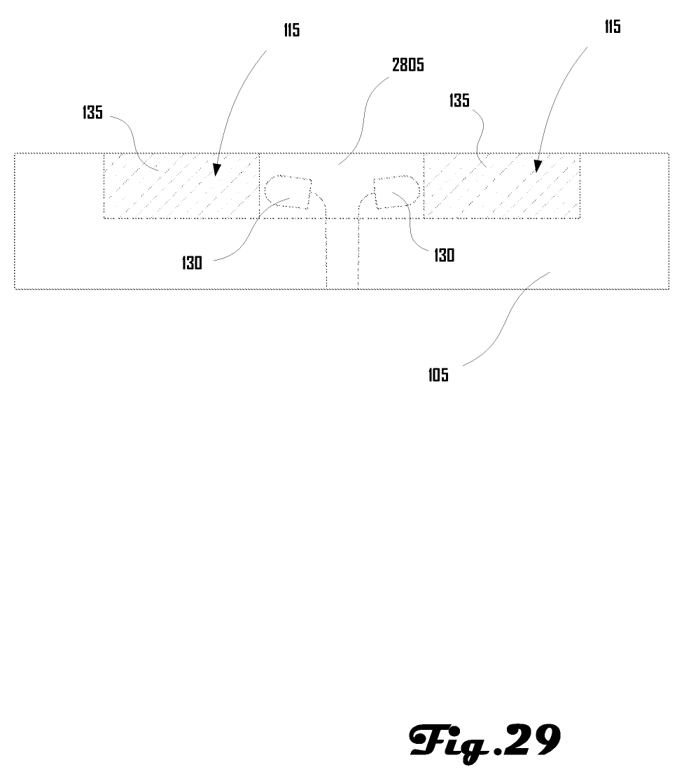

In various embodiments, there may be only one light source 130 or there may be multiple light sources 130. If there are multiple light sources 130, all may in various embodiments be located along the same edge 120 of the recess 115, or they may be located along two or more edges 120. Similarly, in various embodiments, the recess may be larger or smaller, and it may be square, round, or any other shape. As illustrated in FIGS. 28 and 29, there may in alternate embodiments be a raised terrace 2805 in the recess 115 that may house one or more perforations 125 and light sources 130.

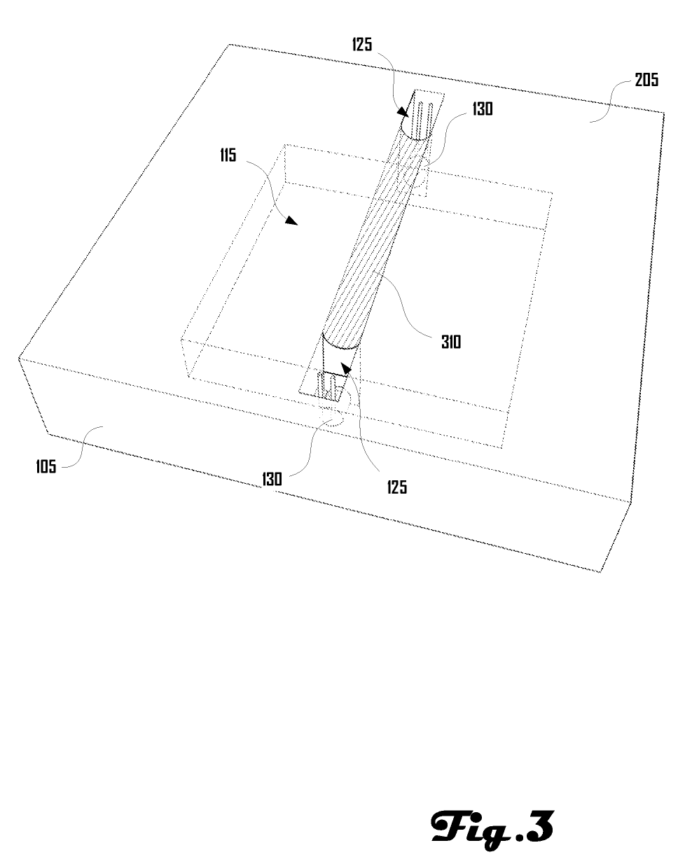

In operative embodiments, the illuminated tile 100 will have a power supply of some description. In a simple embodiment, the power source may be nothing more than a wire for connecting the light source(s) 130 to an external source of electricity. FIG. 3 is a view of the underside of the illuminated tile illustrated in FIG. 1, showing that the perforations 125 are connected with a channel 310 to house such a wire or wires. The channel 310 may allow the power source to be recessed into the base 105 so that the lower surface 205 of the illuminated tile 105 will sit flush on any surface to which it may be mounted.

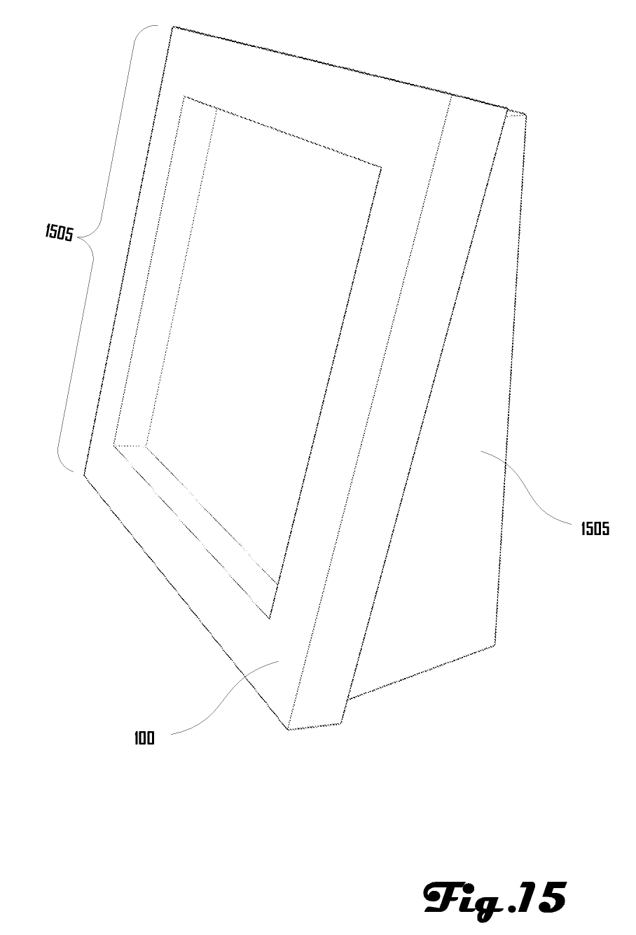

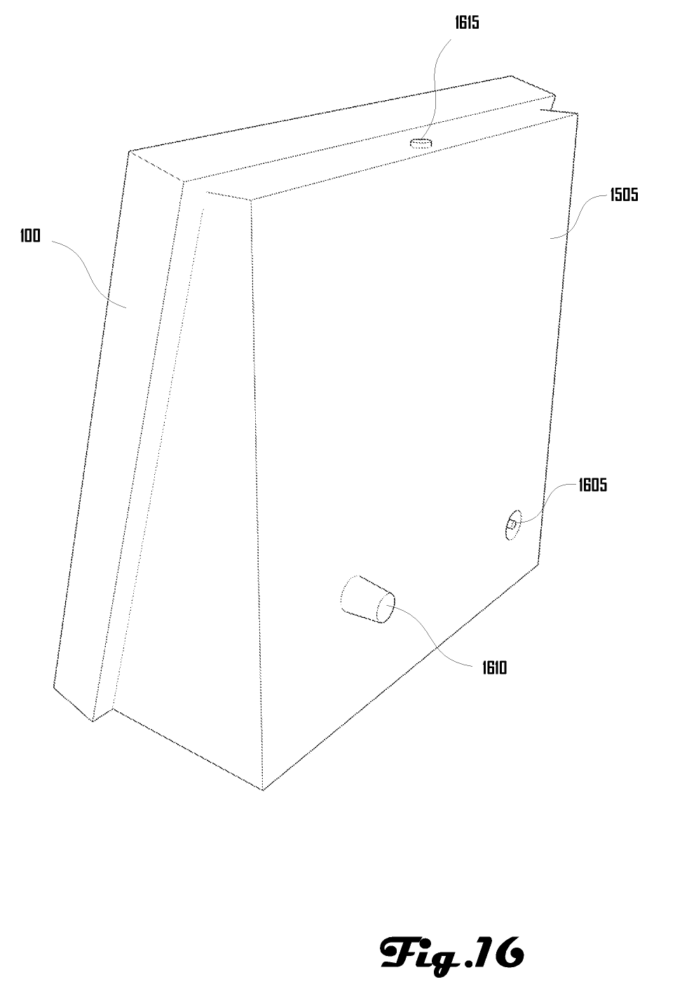

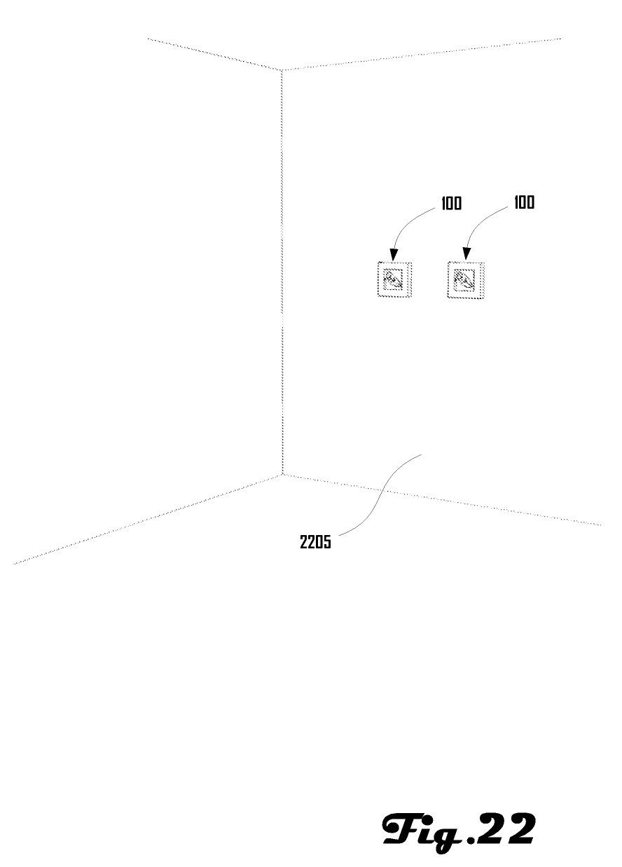

Conventional tiles are commonly used to cover floors, walls, countertops, and other objects such as tabletops. Illuminated tiles 100 may also be used similarly. Often, an illuminated tile 100 may be affixed to a wall, as illustrated in FIG. 22, or to another flat surface, including for example, a floor, countertop, backsplash, or tabletop. In other embodiments, other mounting options are possible. For example, FIGS. 15 and 16 illustrate an illuminated tile 100 coupled to a free-standing stand 1505. In such a configuration, the illuminated tile 100 could be used as a tabletop decorative accent piece. The free-standing stand 1505 may be made of the same material as the illuminated tile 100, or it may be made from any other suitable material. In many embodiments, the free-standing stand 1505 may include additional components, such as a switch 1610, a power connector 1605, and/or a light sensor 1615. In other embodiments, a proximity sensor 1505 may be embedded in or incorporated into the base 105 of the illuminated tile 100 or the free-standing stand 1505. Such a proximity sensor 1505 may in some embodiments operate by sensing the capacitance of nearby bodies.

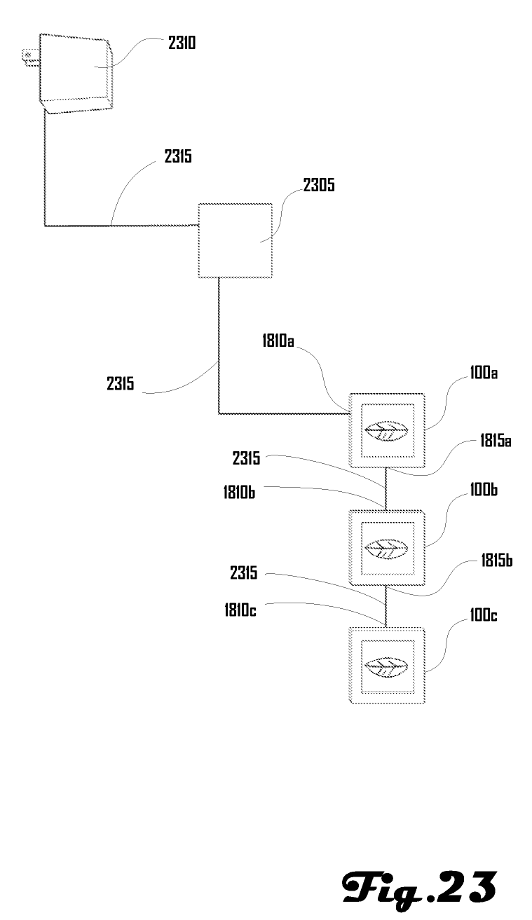

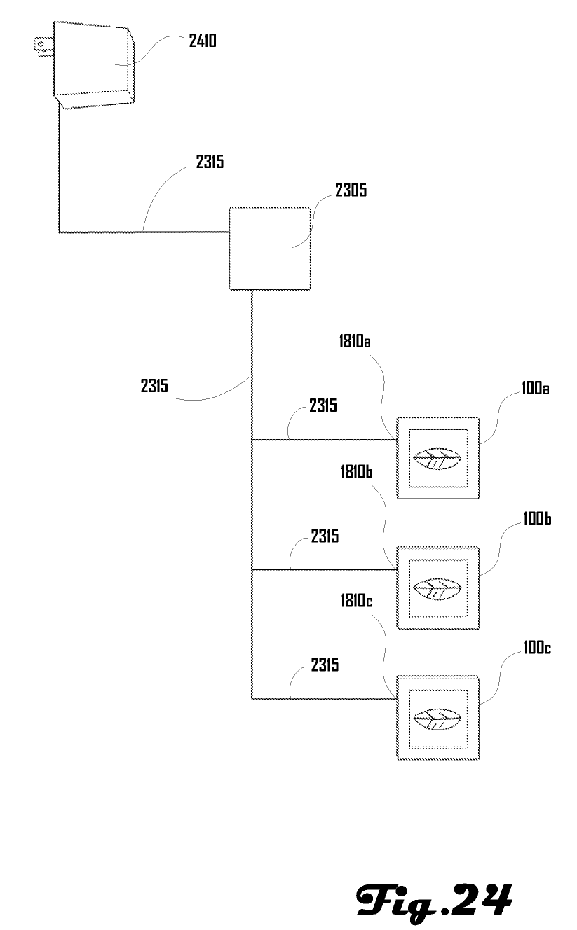

Control mechanisms such as switches, light sensors, proximity sensors, dimmers, and the like may also be utilized in other embodiments and need not be physically coupled to the illuminated tile 100. For example, as illustrated in FIGS. 23 and 24, a connection to the electrical grid or other power source 2310 may be electrically connected via wires 2315 to a remote switch 2305, which is further electrically connected to a group of illuminated tiles 100a-c. If the illuminated tiles 100a-c have only a single power connector 1810a-c, then the group of illuminated tiles 100a-c may be electrically connected in parallel, as illustrated in FIG. 24. If, however, the illuminated tiles 100a-c have a second power connector 1815a-c, then the group of illuminated tiles 100a-c may be electrically connected in series, as illustrated in FIG. 23. In some embodiments, the switch 2305 may be embedded in yet another tile that may or may not be illuminated. The switch 2305 may use any suitable technology, including light sensors, proximity sensors, mechanical switches, and the like.

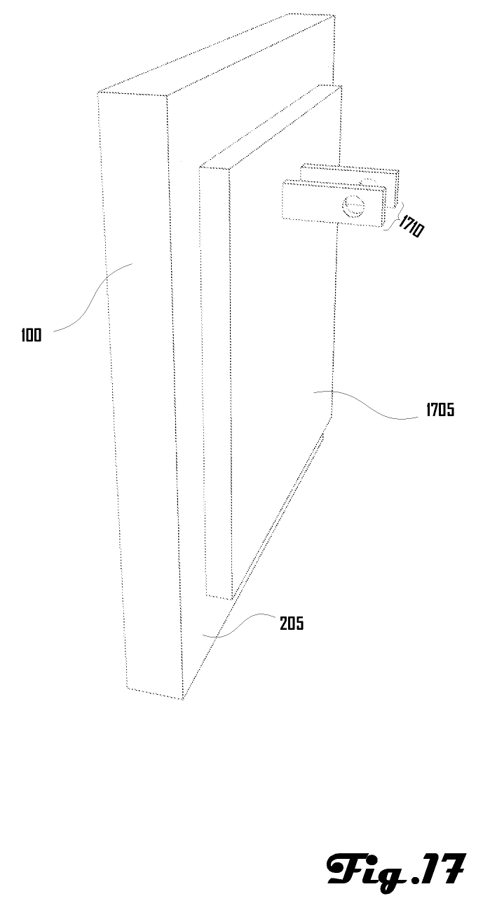

FIG. 17 illustrates yet another embodiment, in which a substrate 1705 is coupled to the lower surface 205 of an illuminated tile 100. In this embodiment, the substrate 1705 houses a power source having a “domestic power plug” 1710. Exemplary domestic power plugs 1710 are male electrical connectors that fit into female electrical sockets. Domestic power plugs 1710 typically have pin or blade contacts that connect mechanically and electrically to holes or slots in a socket (not shown). Domestic power plugs 1710 are typically used to connect home appliances and portable fixtures, such as to the illuminated tile 100 illustrated in FIG. 17, to the commercial power supply so that electric power can flow to them. An illuminated tile 100 that is configured as illustrated in FIG. 17 may be easily and temporarily mounted into any available electrical socket and may thus be advantageously employed as a nightlight.

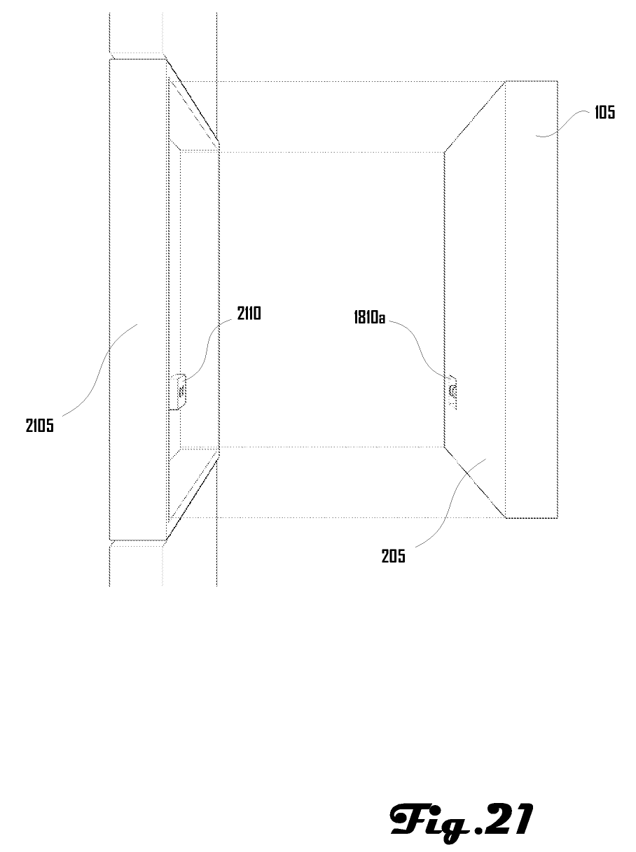

In a further embodiment, as illustrated in FIG. 21, an illuminated tile 100 may be removably mounted in a connector box 2105 that may be permanently attached to a surface, such as a wall. In such embodiments, a power supply connector 1810a may be placed on the lower surface of the illuminated tile 100 where it may mate with a power supply receptacle 2110 in the connector box 2105. By utilizing such a connector box 2105, different tiles 100 may be conveniently swapped out as desired, avoiding the permanence that characterizes the mounting of many tiles.

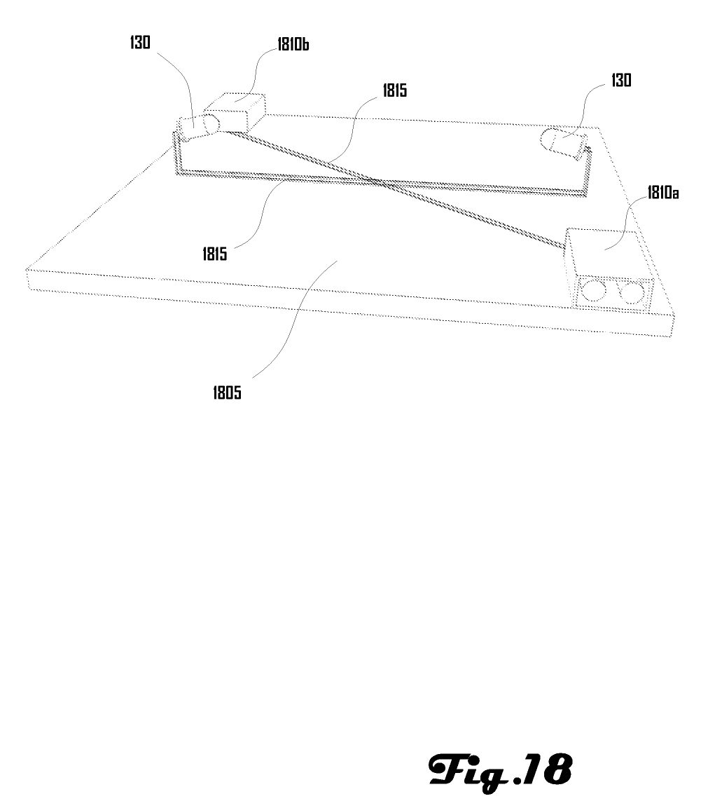

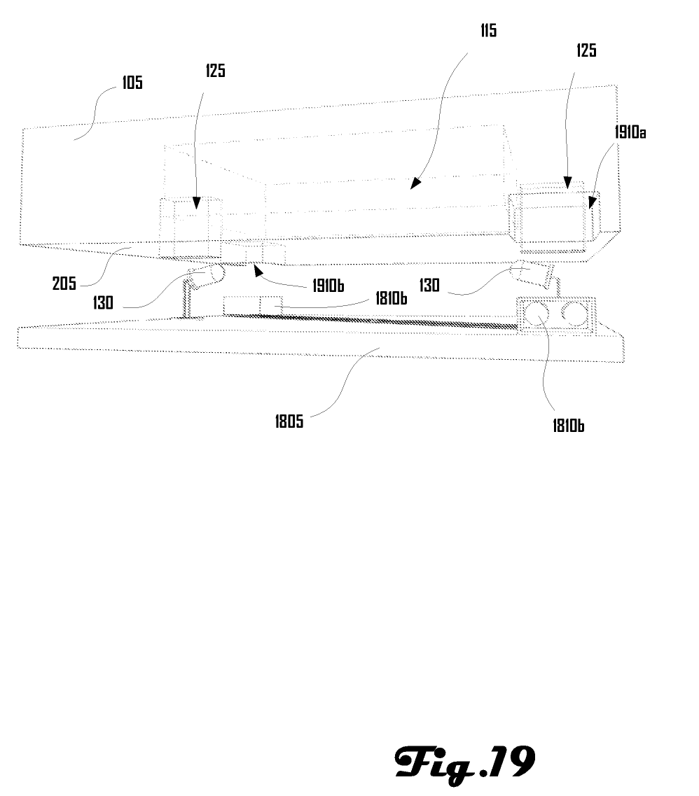

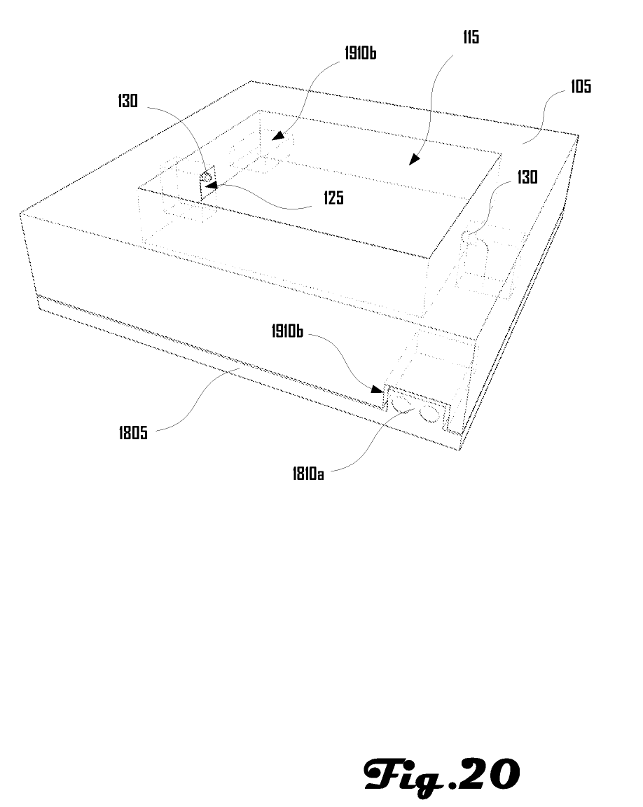

In other embodiments, as illustrated in FIG. 18, a light source 130 and/or a power source connector 1810a-b may be mounted on a substrate, such as a circuit board, perf board, or a piece of plastic or other suitable material, before being mated to a tile base 105. In such an embodiment, as illustrated in FIG. 19, the tile base 105 may have pre-formed cutouts 1910a-b for one or more power source connectors 1810a-b in addition to light source 130 perforations 125, which are common to many embodiments. As with most other embodiments, this embodiment may have one or more light sources 130, and one or more power source connectors 1810a-b. In embodiments having more than one power source connector 1810a-b, there may be an electrical connection 1815 between the power source connectors 1810a-b. In addition, in some embodiments, there may be an electrical connection 1815 between the power source connectors 1810a-b and the light source(s) 130. FIG. 20 is a view of the tile base 105 and substrate 1805 illustrated in FIG. 19 coupled together.

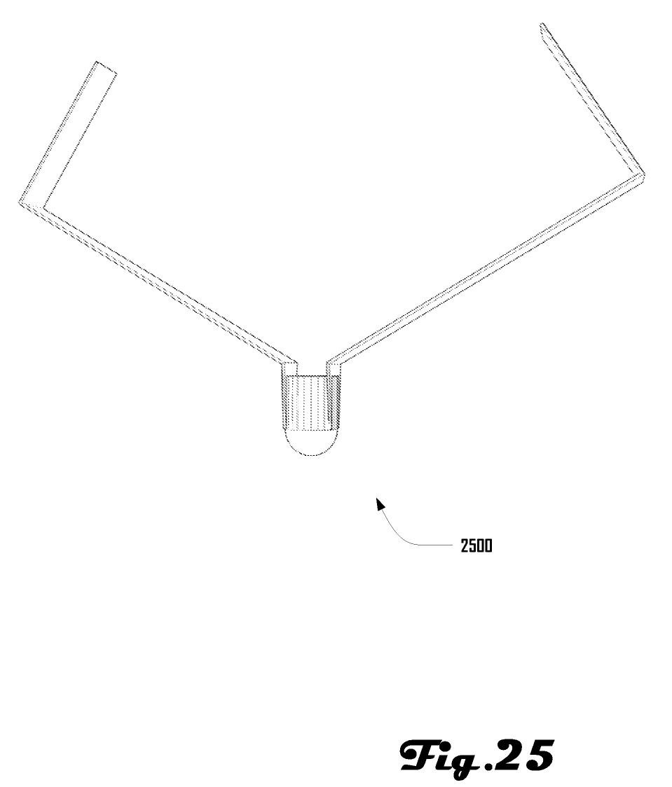

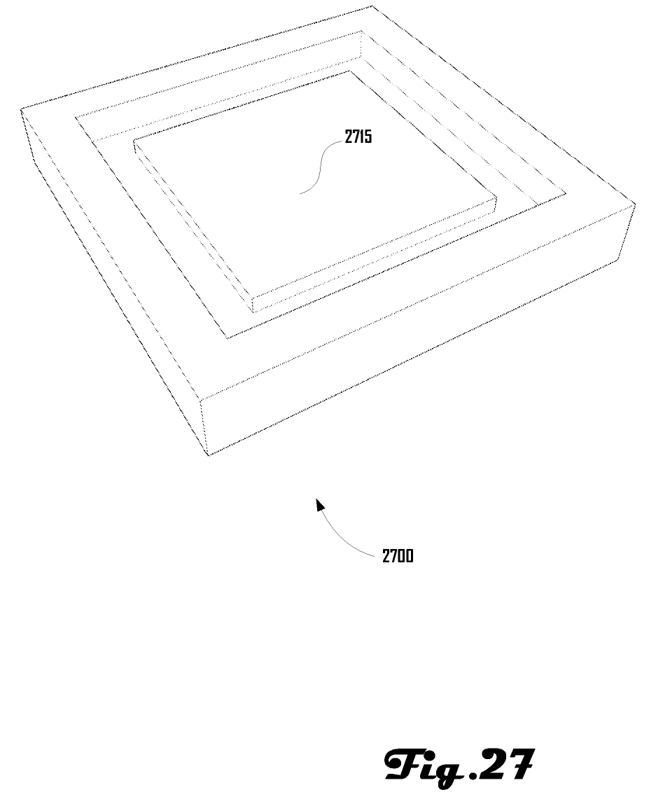

FIGS. 25, 26, and 27 illustrate one possible method for making an illuminated tile 100. A master tile model is used to form a master mold 2700, as illustrated in FIG. 27. The master tile model may be cast or otherwise formed using any number of well known methods for milling, routing, or otherwise shaping a suitable material.

A master mold 2700, is a hollowed-out block that may be filled with a liquid such as concrete, plastic, metal, ceramic, epoxy, plaster, glass, clay, a “composite material,” or the like. The master mold may also be filled with various materials that cold set after mixing of components, including certain plastic resins such as epoxy, water setting materials such as concrete or plaster, and materials that become liquid or liquid-like when moist, such as clay. In many embodiments, the liquid may harden or set inside the mold, adopting the shape of an illuminated tile base 105. A release agent may be used to make removal of the hardened/set substance from the mould easier. In most embodiments, the master mold 2700 may include a raised terrace 2715 that forms the recess 115 in the upper surface 110 of the finished tile base 105.

In some embodiments, the master mold 2700 may be an easily-made one piece mold made from a flexible material such as rubber. In other embodiments, the master mold 2700 may be made from other materials, such as plastic, metal, or other rigid material, and in some embodiments, the master mold 2700 may be a two piece mold.

Composite materials are engineered materials made from two or more constituent materials with different physical or chemical properties that remain separate and distinct on a macroscopic level within the finished structure. Examples of composite materials include concrete, fiberglass, carbon fiber reinforced plastic, cast iron, and the like.

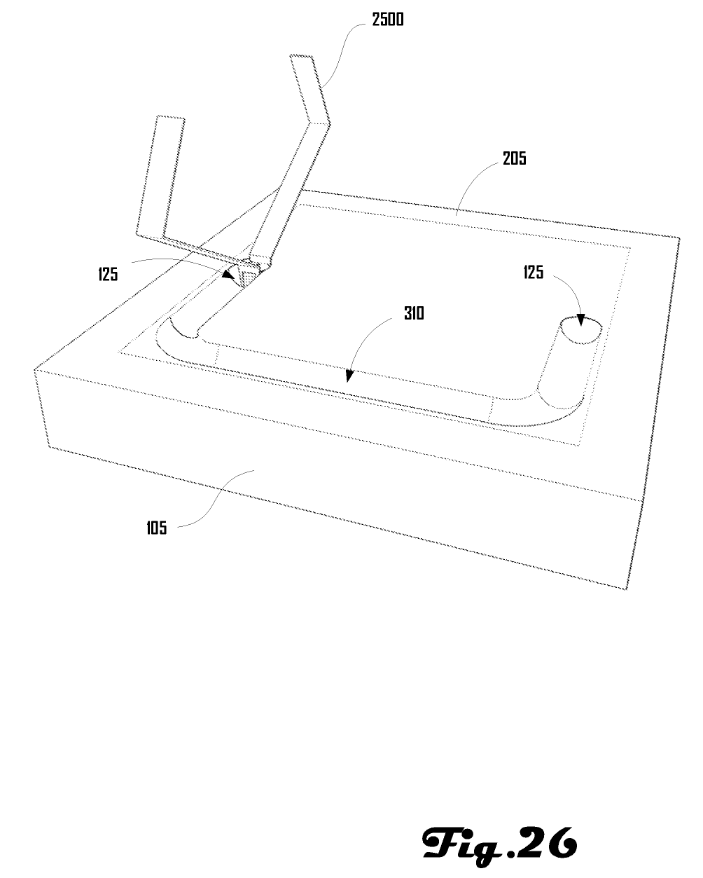

While the material filling the master mold 2700 is workable, additional structural components not formed by the mold may be formed. Examples of such additional structural components include perforations for a light source 130, cutouts for a power source connector 1810, channels 310 for wires or other electrical connectors, or the like. FIG. 25 illustrates one embodiment of a tool 2500 that may be used to form certain additional structural components. FIG. 26 illustrates such a tool 2500 used to form perforations 125 and a channel 310 in the lower surface 205 of a tile base 105. In various embodiments, more or fewer additional structural components may be formed, depending on the number and placement of light sources 130, power source connectors 1810, electrical connections, and the like.

In various embodiments, light sources 130 may be inserted into the perforations 125 thus formed and fixed in place. In other embodiments, a substrate 1805 housing a light source 130 and/or a power supply connector 1810 may be affixed to the lower surface of the molded tile base 105. In some embodiments, the angle of the light sources 130 may be adjusted to effect a desired level of light reflection, as discussed above.

In some embodiments, one or more edges 120 and/or the bottom 210 of the recess 115 may be coated with a reflective coating 405, a textured coating 505, paint, or the like.

A light-transmissive medium 135 is introduced into the recess 115 of the tile base 105. In some embodiments, an object 805 or a transparency 710 may be embedded into the light-transmissive medium 135. In some embodiments, more than one layer of light-transmissive medium 135 may be introduced into the recess 115. In some embodiments, an object 805 or a transparency 710 may be fixed between layers of light-transmissive medium 135.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. An illuminated tile comprising:
a base comprising an upper surface and a lower surface;
said upper surface having a recess;
said recess having an edge and a bottom,
said recess filled with a light-transmissive medium having an upper surface;
a light source coupled with said light-transmissive medium;
said light source directed away from said upper surface of said light-transmissive medium; and
a power source coupled with said light source.

2. The illuminated tile of claim 1 wherein said base is composed of a material selected from at least one of concrete, plastic, wood, metal, ceramic, epoxy, plaster, stone, glass, crystal, and composite material.

3. The illuminated tile of claim 1 wherein said base is affixed to a surface.

4. The illuminated tile of claim 1 wherein said base is coupled to a stand.

5. The illuminated tile of claim 1 wherein at least said bottom of said recess has a reflective coating.

6. The illuminated tile of claim 1 wherein at least said bottom of said recess has a textured coating.

7. The illuminated tile of claim 1 wherein said light-transmissive medium comprises a hardened liquid.

8. The illuminated tile of claim 7 wherein said light-transmissive medium is selected from at least one of plastic, glass, polymer, epoxy, resin, and amber.

9. The illuminated tile of claim 1 wherein said light-transmissive medium comprises a plurality of light-transmissive layers.

10. The illuminated tile of claim 1 further comprising an object embedded in said light-transmissive medium.

11. The illuminated tile of claim 10 wherein said light source is directed to illuminate said object.

12. The illuminated tile of claim 10 wherein said object is light-transmissive.

13. The illuminated tile of claim 12 wherein said object comprises a printed image.

14. The illuminated tile of claim 13 wherein said printed image is selected from at least one of a company logo, a team logo, and a customized image.

15. The illuminated tile of claim 1 wherein said light source is selected from at least one of an LED, optical fiber, incandescent lamp, halogen lamp, compact fluorescent lamp, and luminescent source.

16. The illuminated tile of claim 1 wherein the angle of said light source with respect to the normal to said upper surface of said light transmissive medium is greater than the critical angle.

17. The illuminated tile of claim 1 wherein said light source is mounted on a substrate coupled with said lower surface of said base.

18. The illuminated tile of claim 1 wherein said power source is coupled with said lower surface and further comprises a domestic power plug.

19. The illuminated tile of claim 1 wherein said power source comprises a battery.

20. The illuminated tile of claim 1 wherein said power source comprises a first connector.

21. The illuminated tile of claim 20 further comprising a container box coupled with said base.

22. The illuminated tile of claim 21, said container box further comprising a second connector coupled with said first connector.

23. The illuminated tile of claim 1 further comprising a control mechanism coupled to said power source.

24. The illuminated tile of claim 23 further comprising a free-standing stand coupled to said control mechanism.

25. The illuminated tile of claim 23 wherein said control mechanism is a switch.

26. The illuminated tile of claim 25 wherein said switch is coupled to a proximity sensor.

27. The illuminated tile of claim 25 wherein said switch is coupled to a light sensor.

28. A method of forming an illuminated tile comprising:
obtaining a master tile model having a recess in its upper surface;
forming a mold from said master tile model;
casting a moldable, hardenable material into said mold;
forming perforations into said material;
obtaining from said material in said mold a hardened tile having a recess in its upper surface;
coupling a light source with said perforations and with said recess of said hardened tile;
coupling a power source to said light source through said perforations; and
coupling a first light-transmissive layer with said recess of said hardened tile and with said light source.

29. The method of claim 28 further comprising:
coupling one or more additional light-transmissive layers with said recess of said hardened tile.

30. The method of claim 28 further comprising coupling an object to said first light-transmissive layer.

31. The method of claim 29 further comprising coupling an object to said one or more additional light-transmissive layers.

32. The method of claim 28 wherein said moldable, hardenable material is at least one of concrete, plastic, metal, ceramic, epoxy, plaster, glass, clay, and composite material.

33. The method of claim 28 further comprising coating with a light-reflective material a surface of said recess of said hardened tile.

34. The method of claim 28 further comprising coating with a textured material a surface of said recess of said hardened tile.

35. The method of claim 28 wherein coupling a light source with said perforations and with said recess of said hardened tile further comprises:
adjusting the angle of said light source with respect to the normal to said upper surface of said hardened tile to be larger than the critical angle.
